(19) United States
(12) Patent Application Publication
(10) Pub. No.: US 2013/0013182 A1
(43) Pub. Date: Jan. 10, 2013

(54) AIRPORT OPERATIONS OPTIMIZATION

(75) Inventors: Dimitris J. Bertsimas, Belmont, MA (US); Michael J. Frankovich, Cambridge, MA (US)

(73) Assignee: MASSACHUSETTS INSTITUTE OF TECHNOLOGY, Cambridge, MA (US)

(21) Appl. No.: 13/176,033

(22) Filed: Jul. 5, 2011

(51) Int. Cl. G08G 5/06

(52) U.S. Cl. 701/120

(57) ABSTRACT

Described are computer-based methods and apparatuses, including computer program products, for airport operations optimization. In some examples, a method for airport operations optimization includes generating a runway configuration for a time period based on runway information. The method further includes generating a flight-to-runway assignment for the first time period based on flight information. The method further includes generating a sequence of flights for the time period based on the runway configuration, the flight-to-runway assignment, and the flight information.

### GOVERNMENT SUPPORT

The invention was supported, in whole or in part, by a grant 6922828 from the MIT Lincoln Laboratory. The invention was supported, in whole or in part, by a grant 6915999 from the National Science Foundation. The Government has certain rights in the invention.

### BACKGROUND

Airport operations optimization is, generally, focused on solving single problems within the airport operations environment. These single problems within the airport operations environment are, generally, solved in isolation without consideration of other problems within the airport operations environment. In this regard, a sequencing problem for a single runway (also known as an application of the Traveling Repairman Problem) is solved in isolation (e.g., to minimize a sum of the waiting times of each flight). However, a holistic solution to the airport operations environment is challenging, if not impossible, due to the large number of variables for airport operations (e.g., flights, runways, sequences, gates, fixes). Thus, a need exists in the art for improved airport operations optimization methods and systems.

### SUMMARY

One approach is a method for airport operations optimization. The method includes (a) generating a runway configuration for a first time period based on runway information; (b) generating a flight-to-runway assignment for the first time period based on flight information; and (c) generating a sequence of flights for the first time period based on the runway configuration, the flight-to-runway assignment, and the flight information.

Another approach is a computerized method for airport operations optimization. The method includes generating, via a processor, a runway configuration for a time period based on runway information; generating, via the processor, a flight-to-runway assignment for the time period based on flight information; generating, via the processor, a sequence of flights for the time period based on the runway configuration, the flight-to-runway assignment, and flight information; and automatically transmitting, via a transceiver, the runway configuration, the flight-to-runway assignment, the sequence of flights, or any combination thereof, to a plurality of aircraft, a flight management system, or any combination thereof.

Another approach is a computer program product, tangibly embodied in an information carrier. The computer program product includes instructions being operable to cause a data processing apparatus to generate a runway configuration for a time period based on runway information; generate a flight-to-runway assignment for the time period based on flight information; and generate a sequence of flights for the time period based on the runway configuration, the flight-to-runway assignment, and flight information.

Another approach is an airport operations optimization system. The system includes a runway configuration module configured to determine a runway configuration for a time period based on runway information, the runway configuration comprising a plurality of physical runway identifications and a mode of operation for each of the plurality of physical runway identifications; a flight-to-runway assignment module configured to determine a flight-to-runway assignment for the time period based on flight information; and a flight sequence module configured to generate a sequence of flights for the time period based on the runway configuration, the flight-to-runway assignment, and flight information, the flight information comprising a plurality of flight types, each of the plurality of flight types comprising a weight classification, a flight orientation, or any combination thereof.

In some examples, any of the approaches above can include one or more of the following features.

In some examples, the flight information comprises a plurality of flights for the first time period, each flight of the plurality of flights being associated with a flight type of the plurality of flight types, and each flight type of the plurality of flight types being associated with one or more flights of the plurality of flights.

In some examples, each of the plurality of flight types comprises a weight classification, a flight orientation, or any combination thereof.

In some examples, step (a) further comprises determining the runway configuration for the first time period based on runway information, weather information, and flight information.

In some examples, the runway configuration, the flight-to-runway assignment, and the sequence of flights are generated such that a weighted time corresponding to the sequence of flights is minimized.

In some examples, the method further includes automatically and iteratively repeating steps (a), (b), and (c) for a second time period after the first time period.

In some examples, a dimensionality of steps (a), (b), and (c) is reduced by processing steps (a), (b) and (c) based on a shortest ground route for each flight.

In some examples, the method further includes (d) determining a plurality of ground route configurations for the first time period based on the flight-to-runway assignment, the sequence of flights, and gate information for the first time period; (e) determining a ground waiting time period for each of a plurality of ground route configurations based on the flight information and the gate information; and (f) selecting the ground route configuration for the first time period from the plurality of ground route configurations based on the ground waiting time period for each of the plurality of ground route configurations.

In some examples, the method further includes automatically and iteratively repeating steps (a), (b), (c), (d), (e), and (f) for a second time period after the first time period.

In some examples, each of the ground route configurations comprises taxiway information from a gate to a runway or a runway to a gate, a taxiway flight sequence, or any combination thereof.

In some examples, the taxiway flight sequence specifies a time period for each flight in a plurality of flights to use a taxiway.

In some examples, steps (a), (b), (c) and (f) minimize a total weighted time over all flights in a plurality of flights for the first time period.

In some examples, the method further includes (d) determining a plurality of air route configurations for the first time period based on the runway configuration, the flight-to-runway assignment, the sequence of flights and airspace information for the first time period; (e) determining an air waiting time period for each of the plurality of air route configurations based on the flight information and the airspace information; and (f) selecting the air route configuration for the first time period from the plurality of air route configurations based on the air waiting time period for each of the plurality of air route configurations.

In some examples, a dimensionality of steps (a), (b), and (c) is reduced by processing steps (a), (b) and (c) based on a shortest air route for each flight.

In some examples, the method further includes automatically and iteratively repeating steps (a), (b), (c), (d), (e), and (f) for a second time period after the first time period.

In some examples, each of the air route configurations comprises a flight-path in the near-terminal airspace for each flight in a plurality of flights, a flight-path sequence, or any combination thereof.

In some examples, the flight-path sequence specifies a time period for each flight in the plurality of flights to use a flight-path.

In some examples, steps (a), (b), (c) and (f) minimize a total weighted time over all flights in the plurality of flights for the first time period.

In some examples, the method further includes (g) receiving airport operations information, the airport operations information comprising weather information, a flight sequence change, an aircraft ground delay, an aircraft flight delay, or any combination thereof; and (h) repeating steps (a), (b), (c), and (g) based on the airport operations information.

In some examples, step (a) further comprises (a-1) determining a runway time delay associated with changing from the runway configuration to a second runway configuration; and (a-2) modifying the runway configuration based on the runway time delay.

In some examples, step (c) further comprises (c-1) determining a waiting time period for each flight in a plurality of flights based on the sequence of flights; and (c-2) selecting the sequence of flights for the first time period from a plurality of sequences of flights based on the waiting time period for each flight in the plurality of flights.

In some examples, the runway configuration comprises a set of runway identifications, each with a corresponding operational mode.

In some examples, the sequence of flights comprises a time for each flight in the plurality of flights to take off or land.

In some examples, a dimensionality of steps (a), (b), and (c) is reduced by determining the sequence of flights for each runway based on flight types, and not based on unique flight identifiers.

In some examples, the method further includes determining a sequence of time slots for each flight type, wherein any eligible flight of the flight type can be assigned to a time slot within the sequence of time slots for the flight type. In some examples, each flight travels along a path from gate to runway, runway to fix, fix to runway, runway to gate, or any combination thereof and the path is of substantial duration close to a duration of a respective shortest possible path.

In some examples, the system includes a ground route configuration module configured to generate a ground route configuration for the time period based on the sequence of flights for the time period and gate information for the time period.

In some examples, the system includes a gate delay module configured to determine, for each flight, a gate delay time period based on the sequence of flights and the ground route configuration to minimize a weighted taxiway delay.

In some examples, the system includes an air route configuration module configured to generate an air route configuration for the time period based on the sequence of flights for the time period and airspace information for the time period.

In some examples, the system includes a communication module configured to communicate the runway configuration, the flight-to-runway assignment, the sequence of flights, a ground route configuration, an air route configuration, or any combination thereof, to a plurality of aircraft, a flight management system, or any combination thereof.

The airport operations optimization techniques described herein can provide one or more of the following advantages. An advantage of the technology is that the splitting of the airport operations sequencing decisions into two or more processes (i.e., selection of runway configuration, assignment of flights to runways, and sequencing of flights at each runway, and then the routing of flights within the terminal area and near terminal airspace) enables the technology to reduce the dimensionality of the problem, thereby increasing the frequency with which the problem can be solved (e.g., update based on new flight information, update based on weather information). Another advantage of the technology is that the flights are categorized by flight type to reduce the variables processed by the technology, thereby decreasing the processing resources needed by the technology to optimize the airport operations.

Another advantage of the technology is that a weighted cost of the time spent by each flight at the gate, on the airport surface, and in the near-terminal airspace is minimized, thereby decreasing the cost to operate the airport and/or aircraft associated with the airport. Another advantage of the technology is that the decisions made ensure that safety procedures are respected (e.g., minimum separation is maintained between aircraft).

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 illustrates an exemplary environment for applying airport operations optimization methods;

FIG. 2 illustrates another exemplary environment for applying airport operations optimization methods;

FIG. 3 is a diagram of an exemplary airport operations optimization system;

FIG. 4 is a flowchart illustrating an exemplary airport operations optimization method;

FIG. 5 is a flowchart illustrating another exemplary airport operations optimization method; and

FIG. 6 is a flowchart illustrating another exemplary airport operations optimization method.

### DETAILED DESCRIPTION

Airport operations optimization systems and methods include technology that, generally, uniformly optimizes air traffic flow management issues at an airport. The technology directs flights where to go within an airport environment (e.g., gate, fix, runway, taxiway) and when to go to the location within the airport environment. The technology advantageously reduces the dimensionality of the optimization by reducing the variables considered in managing air traffic and ground traffic flow, thereby enabling the airport operations to be quickly optimized which decreases delays, decreases fuel use and emissions, and decreases safety risks (e.g., reduced problem size from 210,000 constraints and 10,000 variables to 4,000 constraints and 4,000 variables; reduced problem size from 484,000 constraints and 22,000 variables to 10,000 constraints and 8,000 variables).

For example, in one embodiment, the technology described herein reduces the number of variables by utilizing flight types instead of a variable for every flight for the sequence of flights to land/take off. The technology optimizes runway configuration selection, flight-to-runway assignment, sequencing of flights, gate/fix assignments, and/or route configurations, thereby advantageously minimizing a weighted cost of the time spent by each flight at a gate, on the airport surface (e.g., taxiway, runway), and in the near-terminal airspace. For example, in one embodiment, the runway configuration includes a selection of runways which are open at that time and whether the runways will process arrivals and/or departures. For example, in one embodiment, the sequence of flights includes the times at which, and ordering in which flights take off or land. For example, in one embodiment, the gate/fix assignments include gate assignment of arrivals, fix assignment and/or gate pushback times for departures). For example, the route configurations include ground route configurations and/or air route configurations.

The technology can, for example, utilize a network model of the terminal area and near-terminal airspace, discretize the time horizon into time periods, and represent the airport operations decisions by {0,1} decision variables. The technology can, for example, utilize two {0,1} integer optimizations: (1) runway configuration selection, flight-to-runway assignment, and sequencing of flights; and (2) gate/fix assignment and route selection. In one embodiment, the first {0,1} integer optimization utilizes a flight type (e.g., small, heavy, large, Boeing-757) to decrease the dimensionality of the optimization by decreasing the number runway separation constraints required and/or the number of required variables (e.g., separation of 3 minutes between two flights of type C at the same runway, separation of 4 minutes when a flight of type A is followed by a flight of type B) instead of utilizing each individual flight characteristic. The utilization of the flight types enables the technology to make decisions based on safety procedures (e.g., minimum separation is maintained between aircraft).

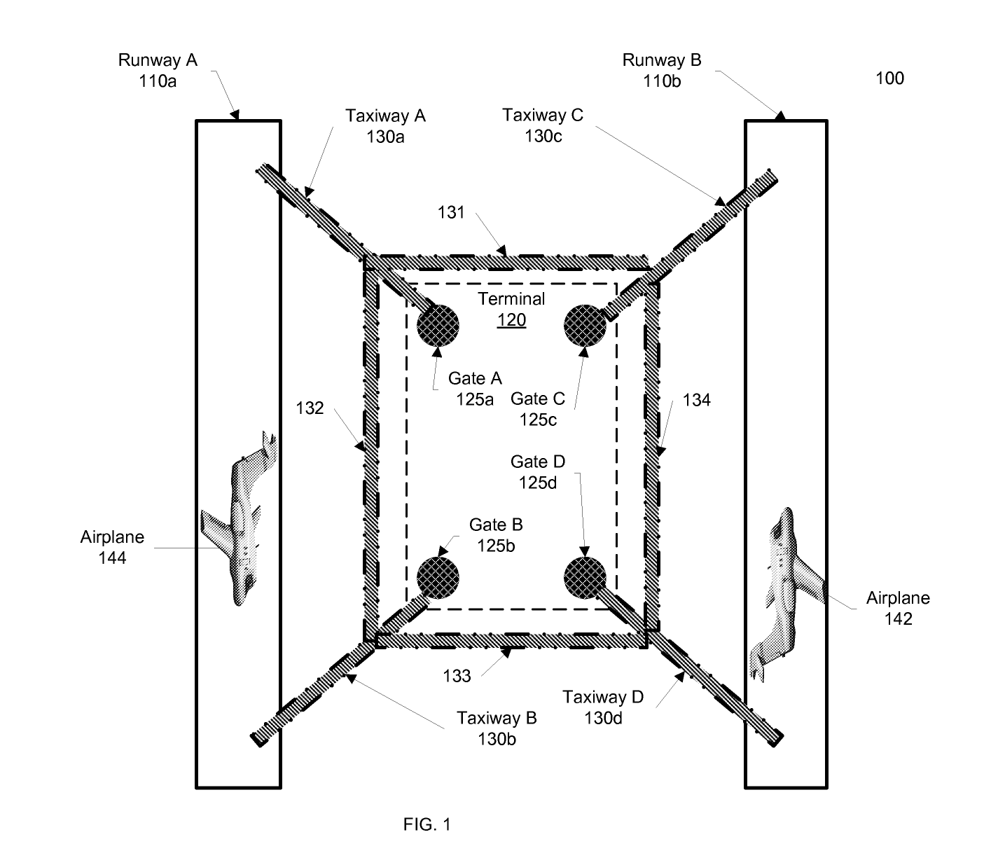

FIG. 1 illustrates an exemplary environment 100 for applying airport operations optimization methods. The environment 100 represents an airport ground environment. The environment 100 includes runways A 110a and B 110b (generally, runways 110), a terminal 120, and taxiways A 130a, B 130b, C 130c, and D 130d (generally, taxiways 130). The runways 110 can operate in arrival/departure/mixed mode. The taxiways 130 are locations within the environment 100 for navigation of airplanes 142 and 144. The terminal 120 includes gates A 125a, B 125b, C 125c, and D 125d (generally, gates 125). The taxiways A 130a, B 130b, C 130c, and D 130d connect the runways A 110a and B 110b to the gates 125. Additional taxiways 131, 132, 133, and 134 connect the taxiways A 130a, B 130b, C 130c, and D 130d together.

The airplanes 142 and 144 utilize the runways A 110a and B 110b to take off and/or land. The airplanes 142 and 144 utilize the taxiways 130 to travel from point to point within the environment 100. The airplanes 142 and 144 may utilize the taxiways 130 and/or the gates 125 and/or the runways 110 as origination and/or termination locations within the environment 100. For example, the airplane 144 travels from the runway A 110a (arrival mode) to gate G 125b via the taxiway B 130b. As another example, the airplane 142 travels from the runway B 110b to gate A 125a via the taxiways C 130c, 131, and then A 130a.

The technology described herein optimizes the operation of the airplanes 142 and 144 within the environment 100. For example, the technology determines the sequence of when the airplanes 142 and 144 land/take off and how the airplanes 142 and 144 travel within the environment 100. Table 1 illustrates exemplary ground route configurations that are possible for the airplanes 142 and 144.

TABLE 1
Exemplary Ground Route Configurations

| | | | | | | Ground |
|---|---|---|---|---|---|---|
| | | Runway | | Ground | | Route |
| Airplane | Runway | Time | Orientation | Route | Taxiway | Time |
| Airplane | Runway B | 20:40 to | Land | Runway B | Taxiway C | 21:41 to |
| 142 | 110b | 21:41 | | 110b to | 130c, | 21:45, |
| | | | | Gate D | Taxiway 134 | 21:45 to |
| | | | | 125d | and | 21:50, |
| | | | | | Taxiway D | 21:50 to |
| | | | | | 130d | 21:52 |
| Airplane | Runway A | 22:25 to | Take Off | Gate A | Taxiway A | 22:18 to |
| 144 | 110a | 22:27 | | 125a to | 130a | 22:24 |
| | | | | Runway A | | |
| | | | | 110a | | |

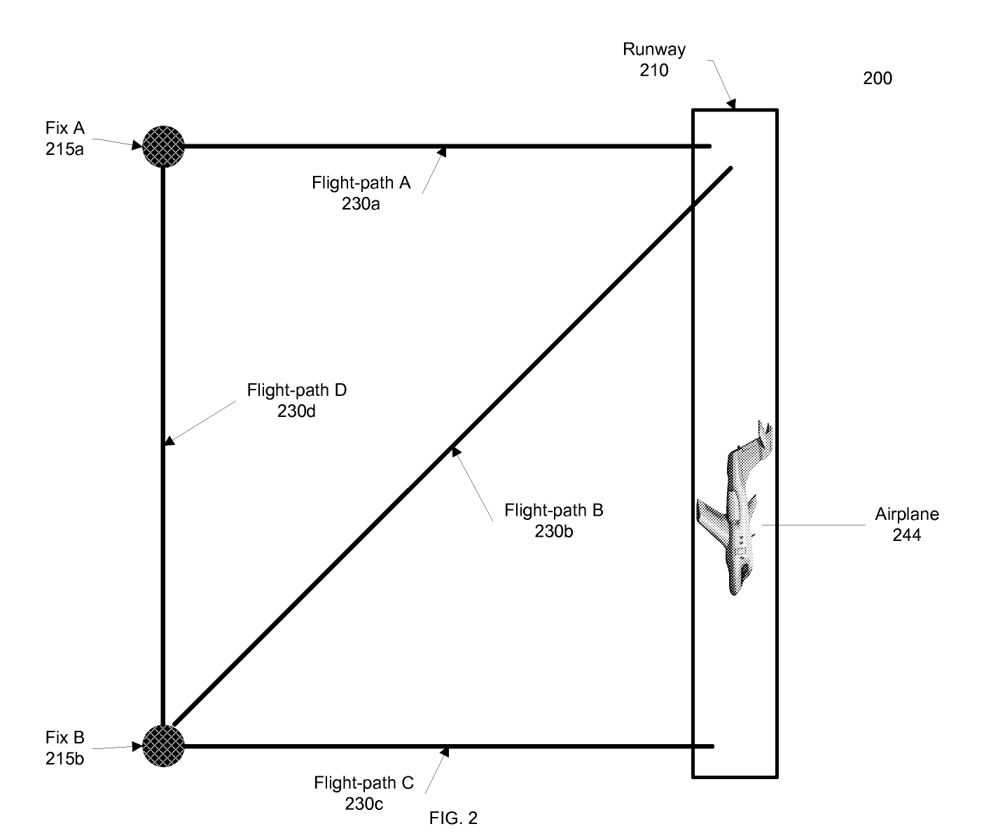

FIG. 2 illustrates another exemplary environment 200 for applying airport operations optimization methods. The environment 200 represents an airport near-terminal environment. The environment 200 includes a runway 210 and fixes A 215a and B 215b (generally, fixes 215). Flight-paths A 230a, B 230b, C 230c, and D 230d define routes that connect the fixes 215 to each other and the runway 210.

Airplane 244 utilizes the runway 210 to take off and/or land. The airplane 244 may utilize the flight-paths A 230a, B 230b, C 230c, and/or D 230d to travel from point to point (e.g., the fixes 215 and the runway 210) within the environment 200. For example, the airplane 244 navigates from the runway 210 to the fix B 215b via the flight-path C 230c. As another example, the airplane 244 navigates from the runway 210 to the fix A 215a via the flight-path C 230c and the flight-path D 230d.

The technology described herein optimizes the operation of the airplane 244 within the environment 200. For example, the technology determines when the airplane 244 lands/takes off and how the airplane 244 travels from runway/fix to runway/fix within the environment 200. Table 2 illustrates an exemplary air route configuration that is possible for the airplane 244.

TABLE 2
Exemplary Air Route Configuration

| | | Runway | | | Flight- | Air Route |
|---|---|---|---|---|---|---|
| Airplane | Runway | Time | Orientation | Air Route | path | Time |
| Airplane | Runway 210 | 18:30.00 to | Take off | Runway 210 | Flight- | 18:30.31 to |
| 244 | | 18:30.30 | | to Fix B | path C | 18:45.00 |
| | | | | 215b | 230c | |

FIGS. 1 and 2 illustrate exemplary environments 100 and 200. The technology can operate in any type of airport environment with any number/configuration of runways, fixes, taxiways, terminals, gates, holding areas and/or flight-paths. The exemplary environments 100 and 200 can operate simultaneously and are illustrated separately for ease of reference. The technology described herein can optimize runway configuration selection, the assignment of flights to runways, the sequencing of flights, ground route configuration and/or air route configuration as a unified optimization.

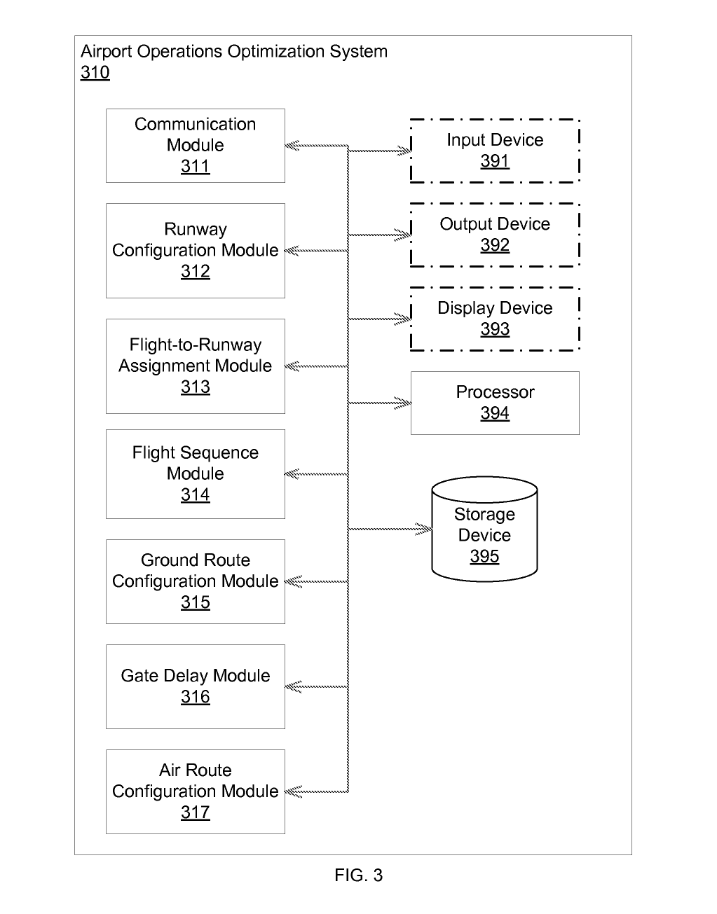

FIG. 3 is a diagram of an exemplary airport operations optimization system 310. The airport operations optimization system 310 includes a communication module 311, a runway configuration module 312, a flight-to-runway assignment module 313, a flight sequence module 314, a ground route configuration module 315, a gate delay module 316, an air route configuration module 317, an input device 391, an output device 392, a display device 393, a processor 394, and a storage device 395. The modules and devices described herein can, for example, utilize the processor 394 to execute computer executable instructions and/or include a processor to execute computer executable instructions (e.g., an encryption processing unit, a field programmable gate array processing unit, etc.). It should be understood that the computing device 310 can include, for example, other modules, devices, and/or processors known in the art and/or varieties of the illustrated modules, devices, and/or processors.

The communication module 311 transmits and/or receives information to/from the airport operations optimization system 310. The communication module 311 communicates the runway configuration, the flight-to-runway assignment, the sequence of flights, a ground route configuration, and/or an air route configuration to a plurality of aircraft and/or a flight management system (not shown).

The runway configuration module 312 determines a runway configuration to be used by one or more airplanes for a time period (e.g., 30 minutes, one hour, four minutes) based on runway information (e.g., available runways, current runway configuration, available operational modes). The runway configuration includes a plurality of runway identifications and a mode of operation for each of the plurality of runway identifications.

The runway configuration module 312 can utilize a runway time change in the determination of whether to keep the existing runway configuration or change the runway configuration to be used by one or more airplanes. In other words, if the airport changes the runway configuration, the delay with this switchover is included in the cost determination for making the change. For example, if runway A 110a is operating in arrival mode from the south, a change to arrival mode from the north is a one minute runway change delay. As another example, if runway A 110a is operating in arrival mode from the south, a change to take off mode from the north is a three minute runway change delay. Table 3 illustrates exemplary runway information. Table 4 illustrates an exemplary runway configuration.

TABLE 3
Exemplary Runway Information

| Runway Identifier | Operational Modes |
|---|---|
| Runway A | Arrival/Departure/ |
| 110a | Mixed |
| Runway B | Arrival/Departure |
| 110b | |
| Runway C | Arrival/Departure/ |
| | Mixed |

TABLE 4
Exemplary Runway Configuration

| Runway Identifier | Time Period |
|---|---|
| Runway A | 21:00 to 21:59 |
| 110a - Arrivals | |
| Runway B | 21:00 to 21:59 |
| 110b - Departures | |
| Runway C - | 21:00 to 21:59 |
| Departures | |
| Runway D - | 21:00 to 21:59 |
| Arrivals | |

The flight-to-runway assignment module 313 determines a flight-to-runway assignment for the time period based on flight information (e.g., flight identifier, flight type, flight direction, arrival/departure time, weight information). The flight-to-runway assignment matches the flights with the respective runways during the set time period. For example, if flight A is arriving and runway A 110a is the only arrival runway, flight A is assigned to runway A 110a. Table 5 illustrates exemplary flight information utilized by the flight-to-runway assignment module 313 for the determination of the flight-to-runway assignment. For example, the flight-to-runway assignment module 313 assigns every arriving flight with a runway in arrival operational mode. Table 6 illustrates an exemplary flight-to-runway assignment.

TABLE 5
Exemplary Flight Information

| | | | Arrival/ |
|---|---|---|---|
| Flight | | Arrival/ | Departure |
| Identifier | Flight Type | Departure | Time Window |
| Flight A | Heavy-A | Arrival | 18:31-18:50 |
| Flight B | Light-D | Departure | 18:32-18:35 |
| . . . | . . . | . . . | . . . |
| Flight Z | 757-D | Departure | 18:39-18:50 |

TABLE 6
Exemplary Flight-to-Runway Assignment

| Flight | |
|---|---|
| Identifier | Runway Identifier |
| Flight A | Runway A |
| | 110a - Arrivals |
| Flight B | Runway B |
| | 110b - Departures |
| . . . | . . . |
| Flight Z | Runway C - |
| | Departures |

The flight sequence module 314 generates a sequence of flights for the time period based on the runway configuration, the flight-to-runway assignment, and flight information. The flight information includes a plurality of flight types and each of the plurality of flight types includes a weight classification and/or a flight orientation. Generating the sequence of flights is simplified by assigning the sequence based on flight types. The use of flight types rather than the use of each flight as a distinct element reduces the number of variables per time period (e.g., 90 flights to 4 flight types, 200 flights to 5 flight types), thereby decreasing the processing time to generate the sequence of flights. In other words, if the technology is using four flight types, the complexity of the sequence of flights is reduced from n distinct flights to a factor of four (e.g., from a×b×n to a×b×4). Table 7 illustrates exemplary flight types. Table 8 illustrates an exemplary flight type sequence with assigned times. Table 9 illustrates an exemplary sequence of flights with assigned times.

TABLE 7
Exemplary Flight Types

| | Flight |
|---|---|
| Flight Type | Orientation |
| Heavy-A | Arrival |
| Light-D | Departure |
| . . . | . . . |
| Other-A | Arrival |

TABLE 8
Exemplary Flight Type Sequence

| | | Runway | Runway |
|---|---|---|---|
| Sequence | Flight Type | Identifier | Time |
| 1 | Heavy-A | Runway A | 18:40 |
| | | 110a - Arrivals | |
| 2 | Light-D | Runway B | 18:34 |
| | | 110b - Departures | |
| . . . | | . . . | |
| 26 | 757-D | Runway C - | 18:45 |
| | | Departures | |

TABLE 9
Exemplary Sequence of Flights

| | Flight | Runway | Runway |
|---|---|---|---|
| Sequence | Identifier | Identifier | Time |
| 1 | Flight A | Runway A | 18:40 |
| | | 110a - Arrivals | |
| 2 | Flight B | Runway B | 18:34 |
| | | 110b - Departures | |
| . . . | . . . | . . . | |
| 26 | Flight Z | Runway C - | 18:45 |
| | | Departures | |

The ground route configuration module 315 generates a ground route configuration for the time period based on the sequence of flights for the time period and gate information (e.g., available gates, flight types for gates) for the time period. The ground route configuration includes directions for a flight to travel from point to point (e.g., gate to runway, runway to gate, taxiway to taxiway) within the environment 100 of FIG. 1. Table 10 illustrates exemplary gate information. Table 11 illustrates an exemplary ground route configuration.

TABLE 10
Exemplary Gate Information

| Gate | Gate Flight | |
|---|---|---|
| Identifier | Type | Availability |
| Gate A 125a | Heavy, Light, | Now-22:50 |
| | Other | |
| Gate B 125b | Light, Other | 22:23-23:33 |
| Gate C 125c | Heavy, Light | 22:32-23:21 |
| Gate D 125d | Heavy, Light, | 22:54-25:21 |
| | Other | |
| . . . | . . . | . . . |

TABLE 11
Exemplary Ground Route Configuration

| Flight | | | |
|---|---|---|---|
| Identifier | From/To | Taxiway | Time |
| Flight A | Runway A | Taxiway A | 22:12.32 to |
| | 110a to Gate A | 130a | 22:14.30 |
| | 125a | | |
| Flight B | Gate D 125d | Taxiway D | 21:12.32 to |
| | to Runway B | 130d | 21:16.30 |
| | 110b | | |
| . . . | | . . . | . . . |
| Flight Z | Gate M to | Taxiway P | 22:16.32 to |
| | Runway C | | 22:17.30 |

The gate delay module 316 determines, for each flight, a gate delay time period (e.g., 10 minute delay, 3 minute delay) based on the sequence of flights and the ground route configuration to minimize a weighted taxiway delay. The determination of the gate delay time period enables the technology to minimize taxiway delays and/or flight delays, thereby reducing the cost of the airport operations (e.g., minimize fuel costs due to flight delays, minimize crew time due to taxiway delays). Table 12 illustrates exemplary gate delay time periods for each flight.

TABLE 12
Exemplary Gate Delay Time Periods

| Flight | | |
|---|---|---|
| Identifier | Gate | Gate Delay |
| Flight B | Gate D 125d | Until 24:30 |
| . . . | | . . . |
| Flight Z | Gate M | Until 23:34 |

The air route configuration module 317 generates an air route configuration for the time period based on the sequence of flights for the time period and airspace information (e.g., available flight-paths, next available flight-path, available fix locations) for the time period. The air route configuration includes directions for a flight to travel from point to point (e.g., fix to runway, runway to fix, fix to fix) within the environment 200 of FIG. 2. Table 13 illustrates exemplary airspace information utilized by the air route configuration module 317 for the generation of the air route configuration. Table 14 illustrates an exemplary air route configuration.

TABLE 13
Exemplary Airspace Information

| Flight | | |
|---|---|---|
| Identifier | Availability | Capacity |
| Flight-path A | 23:34-23:55 | 2 |
| 230a | | |
| Flight-path B | 21:34-24:22 | 3 |
| 230b | | |
| Flight-path C | Now-21:21 | 4 |
| 230c | | |
| Flight-path D | Now-23:21 | 2 |
| 230d | | |

TABLE 14
Exemplary Air Route Configuration

| Flight | | | |
|---|---|---|---|
| Identifier | From/To | Flight-Path | Time |
| Flight A | Fix A 215a to | Flight-path A | 22:11.32 to |
| | Runway 210 | 230a | 22:14.30 |
| Flight B | Runway 210 to | Flight-path C | 21:15.32 to |
| | Fix A 215a | 230c and | 21:17.30 and |
| | | Flight-path D | 21:17.31 to |
| | | 230d | 21:18.30 |
| . . . | | . . . | . . . |
| Flight Z | Runway 210 to | Flight-path C | 19:16.32 to |
| | Fix B 215b | 230c | 19:17.30 |

The input device 391 receives information associated with the airport operations optimization system 310 (e.g., instructions from a user, instructions from another computing device, etc.) from a user (not shown) and/or another computing system (not shown). The input device 391 can include, for example, a keyboard, a scanner, etc. The output device 392 outputs information associated with the airport operations optimization system 310 (e.g., information to a printer (not shown), information to a speaker, etc.).

The display device 393 displays information associated with the airport operations optimization system 310 (e.g., status information, configuration information, etc.). The processor 394 executes the operating system and/or any other computer executable instructions for the airport operations optimization system 310 (e.g., executes applications, etc.).

The storage device 395 stores airport information and/or airport optimization information. The storage device 395 can store information and/or any other data associated with the airport operations optimization system 310. The storage device 395 can include a plurality of storage devices and/or the airport operations optimization system 310 can include a plurality of storage devices (e.g., a position storage device, an absolute satellite position device, etc.). The storage device 395 can include, for example, long-term storage (e.g., a hard drive, a tape storage device, flash memory, etc.), short-term storage (e.g., a random access memory, a graphics memory, etc.), and/or any other type of computer readable storage.

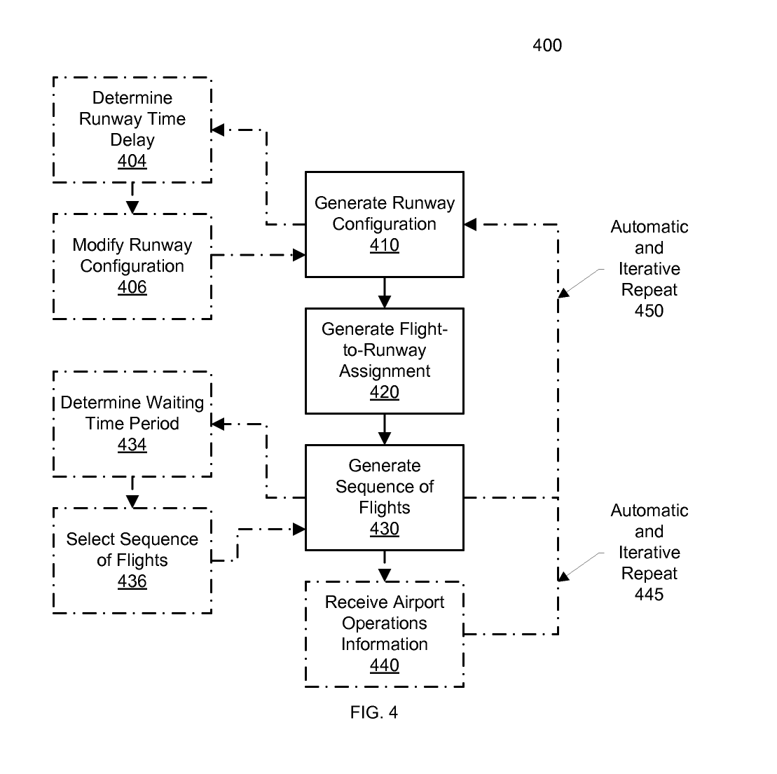

FIG. 4 is a flowchart 400 illustrating an exemplary airport operations optimization method utilizing, for example, the airport operations optimization system 310 of FIG. 3. The runway configuration module 312 generates (410) a runway configuration for a time period based on runway information. The flight-to-runway assignment module 313 generates (420) a flight-to-runway assignment for the time period based on flight information. The flight sequence module 314 generates (430) a sequence of flights for the time period based on the runway configuration, the flight-to-runway assignment, and/or the flight information.

In some examples, the runway configuration module 312, the flight-to-runway assignment module 313, and the flight sequence module 314 automatically and iteratively repeat (450) the generating (410, 420, and 430) steps, respectively, for one or more additional time periods after the time period. Table 15 illustrates an exemplary runway configuration sequence over a given time period.

TABLE 15
Exemplary Runway Configuration Sequence

| Time | Runway Configuration |
|---|---|
| 22:11 to 23:11 | Runway Configuration |
| | BA33 |
| 23:12 to 23:44 | Runway Configuration |
| | BA34 |
| . . . | . . . |
| 08:21 to 09:01 | Runway Configuration |
| | BA55 |

In some examples, a dimensionality of the generating (410, 420, and 430) steps is reduced by processing the generating (410, 420, and 430) steps based on a shortest ground route for each flight. In some examples, the communication module 311 receives (440) airport operations information. The airport operations information can include weather information (e.g., rain delays, snow delays), a flight sequence change (e.g., flight delay, new departure time), an aircraft ground delay (e.g., baggage delay, security delay), and/or an aircraft flight delay (e.g., longer flight, re-routing of flight). In some examples, the runway configuration module 312, the flight-to-runway assignment module 313, the flight sequence module 314, and the communication module 311 automatically and iteratively repeat (445) the generating (410, 420, and 430) and receiving (440) steps, respectively, based on the airport operations information.

In some examples, the runway configuration module 312 further determines (404) a runway time delay associated with changing from the runway configuration to a second runway configuration. The runway configuration module 312 further modifies (406) the runway configuration based on the runway time delay.

In some examples, the flight sequence module 314 further determines (434) a waiting time period for each flight in a plurality of flights based on the sequence of flights. The flight sequence module 314 further selects (436) the sequence of flights for the time period from a plurality of sequences of flights based on the waiting time period for each flight in the plurality of flights.

In some examples, a dimensionality of the generating (410, 420, and 430) steps is reduced by determining the sequence of flights for each runway based on flight types, and not based on unique flight identifiers. In some examples, the sequence of flights is determined by first determining a sequence of flight type slots and the sequence of flight type slots comprises at least one sequence of flights. In some examples, the flight sequence module 314 determines a sequence of time slots for each flight type. For the sequence of time slots for a flight type, any eligible flight of the flight type can be assigned to a time slot within the sequence of time slots for the flight type. For example, for a heavy flight type with four time slots, Flight A, of heavy flight type, can be assigned to any one of the four time slots that it could feasibly achieve. In some examples, each flight travels along a path from gate to runway, runway to fix, fix to runway, and/or runway to gate, and the path is of substantial duration close to a duration of a respective shortest possible path.

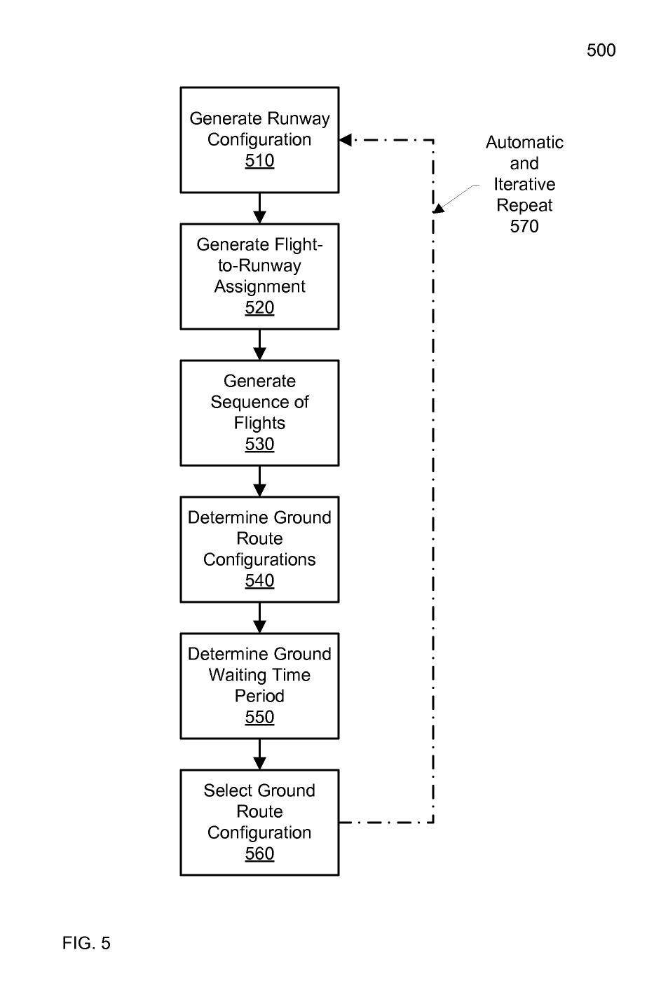

FIG. 5 is a flowchart 500 illustrating another exemplary airport operations optimization method utilizing, for example, the airport operations optimization system 310 of FIG. 3. The runway configuration module 312 generates (510) a runway configuration for a time period based on runway information. The flight-to-runway assignment module 313 generates (520) a flight-to-runway assignment for the time period based on flight information. The flight sequence module 314 generates (530) a sequence of flights for the time period based on the runway configuration, the flight-to-runway assignment, and/or the flight information. The ground route configuration module 315 determines (540) a plurality of ground route configurations for the time period based on the flight-to-runway assignment, the sequence of flights, and gate information for the time period. The ground route configuration module 315 further determines (550) a ground waiting time period for each of a plurality of ground route configurations based on the flight information and the gate information. The ground route configuration module 315 further selects (560) the ground route configuration for the time period from the plurality of ground route configurations based on the ground waiting time period for each of the plurality of ground route configurations.

In some examples, the runway configuration module 312, the flight-to-runway assignment module 313, the flight sequence module 314, and the ground route configuration module 315 automatically and iteratively repeat (570) the generating (510, 520, and 530), the determining (540 and 550), and the selecting (560) steps for one or more additional time periods after the time period.

In some examples, each of the ground route configurations comprises taxiway information from a gate to a runway or a runway to a gate, and/or a taxiway flight sequence. In some examples, the taxiway flight sequence specifies a time period for each flight in a plurality of flights to use a taxiway. In some examples, the generating (510, 520, and 530) and selecting (560) steps minimize a total weighted time over all flights in a plurality of flights for the time period. Table 16 illustrates exemplary weighted times.

TABLE 16
Exemplary Weighted Times

| Location | Weight | Delay | Weighted Time |
|---|---|---|---|
| Gate Waiting | 1 | 2 minutes | 2 minutes |
| Time | | | |
| Ground | 2 | 24 minutes | 48 minutes |
| Waiting Time | | | |
| Air Waiting | 5 | 10 minutes | 50 minutes |
| Time | | | |
| | | Total: | 100 minutes |

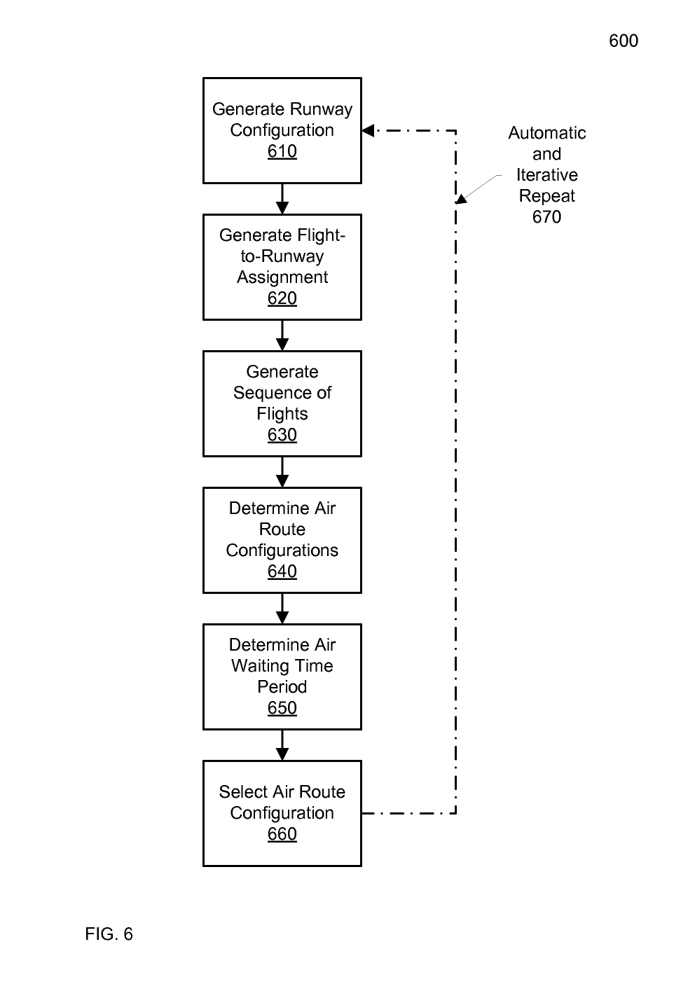

FIG. 6 is a flowchart 600 illustrating another exemplary airport operations optimization method utilizing, for example, the airport operations optimization system 310 of FIG. 3. The runway configuration module 312 generates (610) a runway configuration for a time period based on runway information. The flight-to-runway assignment module 313 generates (620) a flight-to-runway assignment for the time period based on flight information. The flight sequence module 314 generates (630) a sequence of flights for the time period based on the runway configuration, the flight-to-runway assignment, and/or the flight information. The air route configuration module 317 determines (640) a plurality of air route configurations for the time period based on the runway configuration, the flight-to-runway assignment, the sequence of flights and airspace information for the time period. The air route configuration module 317 further determines (650) an air waiting time period for each of the plurality of air route configurations based on the flight information and the airspace information. The air route configuration module 317 further selects (660) the air route configuration for the time period from the plurality of air route configurations based on the air waiting time period for each of the plurality of air route configurations.

In some examples, the runway configuration module 312, the flight-to-runway assignment module 313, the flight sequence module 314, and the air route configuration module 317 automatically and iteratively repeat (670) the generating (610, 620 and 630), the determining (640 and 650), and the selecting (660) steps for one or more additional time periods after the time period.

In some examples, complexity of the generating (610, 620, and 630) steps is reduced by processing the generating (610, 620, and 630) steps based on a shortest air route for each flight. In some examples, each of the air route configurations includes a flight-path in the near-terminal airspace for each flight in a plurality of flights and/or a flight-path sequence. In some examples, the flight-path sequence specifies a time period for each flight in the plurality of flights to use a flight-path. In some examples, the generating (610, 620, and 630) and selecting (660) steps minimize a total weighted time over all flights in the plurality of flights for the first time period.

In some examples, the technology includes a method with the generating (510, 520, and 530) steps, the determining (540, 550, 640, and 650) steps, and the selecting (560 and 660) steps. The determining (540, 550, 640, and 650) steps and the selecting (560 and 660) steps can be processed simultaneously (e.g., 540, 550, and 560 in parallel with 640, 650, and 660) and/or sequentially (e.g., 540, 550, 560, 640, 650, and 660).

In some examples, the flight information includes a plurality of flights for the time period. Each flight of the plurality of flights is associated with a flight type of the plurality of flight types. Each flight type of the plurality of flight types is associated with one or more flights of the plurality of flights. In some examples, each of the plurality of flight types includes a weight classification and/or a flight orientation.

In some examples, the runway configuration module determines the runway configuration for the first time period based on runway information, weather information, and flight information.

In some examples, the runway configuration, the flight-to-runway assignment, and the sequence of flights are generated such that a weighted time corresponding to the sequence of flights is minimized. The time can be weighted based on fuel costs, crew costs, and/or any other variable associated with airport operations.

In some examples, the runway configuration includes a set of runway identifications, each with a corresponding operational mode. In some examples, the sequence of flights includes a time for each flight in the plurality of flights to take off or land.

In some examples, any of the equations and/or decision variables described herein are defined by:
T={1, . . . , T} the set of time intervals comprising the time horizon considered;
C=the set of flight types, each of which is a pair i=(w, o) corresponding to a weight class category w and a flight orientation o;
C_{A}, C_{D}=the set of flight types whose orientation is arrival, departure, respectively;
F=F_{A}∪=F_{D}=∪_{iεC} Fᵢ=the set of flights;
R=the set of runways, each of which is a pair r=(p, d) corresponding to a physical runway p and a direction of operation d;
R_{f}, Rᵢ⊂R,=the set of runways feasible for flight f, some flight of type i, respectively;
K=the set of runway configurations, each of which is a set of triplets k={(pₗ, dₗ, mₗ), . . . , (p_{N}, d_{N}, m_{N})}={(rₗ, mₗ), . . . , (r_{N}, m_{N})}, where m is the mode of operation of a runway (arrivals only/departures only/mixed mode);
Rₖ=the set of runways used by runway configuration k;
Iᵣₖ=the set of flight types that can use runway r under runway configuration k;
Uₜ⊂R,=those runways which cannot be used at time t due, for example, to inclement weather;
T^{f}ᵣ={T^{f}ᵣ, T^{f}ᵣ+1, . . . , \check{T}^{f}ᵣ}=the set of feasible times for flight f to arrive at runway r, considering the flight's starting time and location and the shortest path to r, when unimpeded by traffic;
T^{f}ₒ_{_{f}}=the release time of flight f from its origin (gate or arrival fix) into the system;
s^{rt}ᵢⱼ=the minimum number of time intervals of separation required at runway r and time t when an aircraft of type j follows an aircraft of type i;
l^{r}ᵢₜ=the number of time intervals constituting the runway occupancy time of flights of type i at runway r at time t;
β_{A}, β_{D}=constants weighting the cost in the air relative to on the ground, for arrivals and departures, respectively, with β_{A}>β_{D};
β_{G}=a constant weighting the cost at the gate before pushback relative to when taxiing;
d^{f}ᵣ=a penalty for assigning flight f to runway r;
K=a constant which penalizes each runway configuration changeover.

In some examples, the decision variables for runway configuration use, flight-to-runway assignments, and sequencing of flights are calculated in accordance with:

ωₖₜ=1 if runway configuration k is active at time t, and 0 otherwise;

φ^{f}ᵣ=1 if flight f is assigned to runway r, and 0 otherwise;

ψⁱᵣₜ=1 if a flight of type i is at runway r at time t, and 0 otherwise;

χₜ=1 if a change of runway configuration occurs at time t, and 0 otherwise.

In some examples, the sequence of flights is generated such that the value of Ψ, defined by the following equation, is minimized:

Ψ=β_{G}Σ_{iεC}_{_{D}}Σ_{rεR}_{ᵢ}Σ_{tεT}tψⁱᵣₜ−Σ_{fεF}_{_{D}}[T^{f}ₒ_{_{f}}−Σ_{rεR}_{_{f}}φ^{f}ᵣ(β_{D}d^{f}ᵣ+(1−β_{G})T^{f}ᵣ)]+β_{A}Σ_{iεC}_{_{A}}Σ_{rεR}_{ᵢ}Σ_{tεT}tψⁱᵣₜ−Σ_{fεF}_{_{A}}(β_{A}T^{f}ₒ_{_{f}}−Σ_{rεR}_{_{f}}d^{f}ᵣψ^{f}ᵣ)+KΣ_{tεT}χₜ.

In some examples, any of the equations described herein are defined by:

S=the set of nodes in the airport network;

S_{f}⊂S,=the set of nodes in the airport network feasible for flight f;

L^{f}ᵢ=the set of possible successor nodes of node i for flight f;

P^{f}ᵢ=the set of possible predecessor nodes of node i for flight f;

E_{f}⊂S_{f},=the set of possible end nodes of flight f;

T^{f}ᵢ={T^{f}ᵢ, T^{f}ᵢ+1, . . . , \check{T}^{f}ᵢ}=the set of feasible times for flight f to arrive at node i, considering the flight's starting time and location and the shortest path to i, when unimpeded by traffic;

c_{f}εC,=the type of flight f;

o_{f}=initial node of flight f;

lⁱ_{ft}=the minimum amount of time flight f must spend at node i, should it go there at time t;

uᵢₜ=the capacity of node i, in flights, at time t;

R⊂S,=the set of nodes corresponding to runways;

R_{f}⊂S_{f},=the set of nodes corresponding to runways which are feasible for flight f;

r_{f}εR_{f},=the assigned runway node at which flight f must be processed, based on the optimal φ variables;

t_{f}=the time at which we desire flight f to arrive at r_{f}, based on the optimal ψ variables.

In some examples, the nodes described herein include fixes, gates, taxiways, flight paths, runways, and/or other locations within the airport environment (e.g., de-icing location, ground hold location). In some examples, the decision variables for ground route configurations and air route configurations are calculated in accordance with:

z^{f}ᵢₜ=1 if flight f reaches node i by time t, and 0 otherwise;

x^{f}ᵢₜ=1 if flight f is at node i at time t, and 0 otherwise.

In some examples, the ground route configurations and/or air route configurations are generated such that the value of (I), defined by the following equation, is minimized:

$$Φ = {\sum }_{f ∈ {F}_{D}} [ {β}_{G} ( {γ}_{{o}_{f}}^{f} - {\sum }_{i ∈ {L}_{{o}_{f}}^{f}} {γ}_{i}^{f} ) + {\sum }_{i ∈ {L}_{{o}_{f}}^{f}} {γ}_{i}^{f} - {\sum }_{j ∈ {R}_{f}} {γ}_{j}^{f} + {β}_{D} ( {\sum }_{j ∈ {R}_{f}} {γ}_{j}^{f} - {\sum }_{i ∈ {E}_{f}} {γ}_{i}^{f} ) ] + {\sum }_{g ∈ {F}_{A}} [ {β}_{A} ( {γ}_{{o}_{g}}^{g} - {\sum }_{j ∈ {R}_{g}} {γ}_{j}^{g} ) + {\sum }_{j ∈ {R}_{g}} {γ}_{j}^{g} {\sum }_{i ∈ {E}_{g}} {γ}_{i}^{g} ] ,$$

where γ^{f}ᵢ=Σ^{T}_{t=T}_{^{f}}_{ᵢ}z^{f}ᵢₜ is the length of time from the moment flight f arrives at node i until the end of the time horizon, if flight f does indeed arrive at node i, and 0 otherwise.

In some examples, the technology described herein is executed via a computerized method for airport operations optimization. The method includes generating, via a processor, a runway configuration for a time period based on runway information; generating, via the processor, a flight-to-runway assignment for the time period based on flight information; generating, via the processor, a sequence of flights for the time period based on the runway configuration, the flight-to-runway assignment, and flight information; and automatically transmitting, via a transceiver, the runway configuration, the flight-to-runway assignment, the sequence of flights, or any combination thereof, to a plurality of aircraft. In some examples, the technology described herein optimizes the airport operations in a unified optimization.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatuses. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by special purpose logic circuitry and/or an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory, a random access memory, and/or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for airport operations optimization, the method comprising:
(a) generating a runway configuration for a first time period based on runway information;
(b) generating a flight-to-runway assignment for the first time period based on flight information; and
(c) generating a sequence of flights for the first time period based on the runway configuration, the flight-to-runway assignment, and the flight information.

2. The method of claim 1, wherein the flight information comprises a plurality of flights for the first time period, each flight of the plurality of flights being associated with a flight type of the plurality of flight types, and each flight type of the plurality of flight types being associated with one or more flights of the plurality of flights.

3. The method of claim 2, wherein each of the plurality of flight types comprises a weight classification, a flight orientation, or any combination thereof.

4. The method of claim 1, wherein step (a) further comprises determining the runway configuration for the first time period based on runway information, weather information, and flight information.

5. The method of claim 1, wherein the runway configuration, the flight-to-runway assignment, and the sequence of flights are generated such that a weighted time corresponding to the sequence of flights is minimized.

6. The method of claim 1, further comprising automatically and iteratively repeating steps (a), (b), and (c) for a second time period after the first time period.

7. The method of claim 1, wherein a dimensionality of steps (a), (b), and (c) is reduced by processing steps (a), (b) and (c) based on a shortest ground route for each flight.

8. The method of claim 1, further comprising:
(d) determining a plurality of ground route configurations for the first time period based on the flight-to-runway assignment, the sequence of flights, and gate information for the first time period;
(e) determining a ground waiting time period for each of a plurality of ground route configurations based on the flight information and the gate information; and
(f) selecting the ground route configuration for the first time period from the plurality of ground route configurations based on the ground waiting time period for each of the plurality of ground route configurations.

9. The method of claim 8, further comprising automatically and iteratively repeating steps (a), (b), (c), (d), (e), and (f) for a second time period after the first time period.

10. The method of claim 8, wherein each of the ground route configurations comprises taxiway information from a gate to a runway or a runway to a gate, a taxiway flight sequence, or any combination thereof.

11. The method of claim 10, wherein the taxiway flight sequence specifies a time period for each flight in a plurality of flights to use a taxiway.

12. The method of claim 10, wherein steps (a), (b), (c) and (f) minimize a total weighted time over all flights in a plurality of flights for the first time period.

13. The method of claim 1, further comprising:
(d) determining a plurality of air route configurations for the first time period based on the runway configuration, the flight-to-runway assignment, the sequence of flights and airspace information for the first time period;
(e) determining an air waiting time period for each of the plurality of air route configurations based on the flight information and the airspace information; and
(f) selecting the air route configuration for the first time period from the plurality of air route configurations based on the air waiting time period for each of the plurality of air route configurations.

14. The method of claim 13, wherein a dimensionality of steps (a), (b), and (c) is reduced by processing steps (a), (b) and (c) based on a shortest air route for each flight.

15. The method of claim 13, further comprising automatically and iteratively repeating steps (a), (b), (c), (d), (e), and (f) for a second time period after the first time period.

16. The method of claim 13, wherein each of the air route configurations comprises a flight-path in the near-terminal airspace for each flight in a plurality of flights, a flight-path sequence, or any combination thereof.

17. The method of claim 16, wherein the flight-path sequence specifies a time period for each flight in the plurality of flights to use a flight-path.

18. The method of claim 16, wherein steps (a), (b), (c) and (f) minimize a total weighted time over all flights in the plurality of flights for the first time period.

19. The method of claim 1, further comprising:
(g) receiving airport operations information, the airport operations information comprising weather information, a flight sequence change, an aircraft ground delay, an aircraft flight delay, or any combination thereof; and
(h) repeating steps (a), (b), (c), and (g) based on the airport operations information.

20. The method of claim 1, wherein step (a) further comprises:
(a-1) determining a runway time delay associated with changing from the runway configuration to a second runway configuration; and
(a-2) modifying the runway configuration based on the runway time delay.

21. The method of claim 1, wherein step (c) further comprises:
(c-1) determining a waiting time period for each flight in a plurality of flights based on the sequence of flights; and
(c-2) selecting the sequence of flights for the first time period from a plurality of sequences of flights based on the waiting time period for each flight in the plurality of flights.

22. The method of claim 1, wherein the runway configuration comprises a set of runway identifications, each with a corresponding operational mode.

23. The method of claim 1, wherein the sequence of flights comprises a time for each flight in the plurality of flights to take off or land.

24. The method of claim 1, wherein a dimensionality of steps (a), (b), and (c) is reduced by determining the sequence of flights for each runway based on flight types, and not based on unique flight identifiers.

25. The method of claim 24, further comprising determining a sequence of time slots for each flight type, wherein any eligible flight of the flight type can be assigned to a time slot within the sequence of time slots for the flight type.

26. The method of claim 1, wherein each flight travels along a path from gate to runway, runway to fix, fix to runway, runway to gate, or any combination thereof and the path is of substantial duration close to a duration of a respective shortest possible path.

27. A computerized method for airport operations optimization, the method comprising:
generating, via a processor, a runway configuration for a time period based on runway information;
generating, via the processor, a flight-to-runway assignment for the time period based on flight information;
generating, via the processor, a sequence of flights for the time period based on the runway configuration, the flight-to-runway assignment, and flight information; and
automatically transmitting, via a transceiver, the runway configuration, the flight-to-runway assignment, the sequence of flights, or any combination thereof, to a plurality of aircraft, a flight management system, or any combination thereof.

28. A computer program product, tangibly embodied in an information carrier, the computer program product including instructions being operable to cause a data processing apparatus to:
generate a runway configuration for a time period based on runway information;
generate a flight-to-runway assignment for the time period based on flight information; and
generate a sequence of flights for the time period based on the runway configuration, the flight-to-runway assignment, and flight information.

29. An airport operations optimization system, the system comprising:
a runway configuration module configured to determine a runway configuration for a time period based on runway information, the runway configuration comprising a plurality of physical runway identifications and a mode of operation for each of the plurality of physical runway identifications;
a flight-to-runway assignment module configured to determine a flight-to-runway assignment for the time period based on flight information; and
a flight sequence module configured to generate a sequence of flights for the time period based on the runway configuration, the flight-to-runway assignment, and flight information, the flight information comprising a plurality of flight types, each of the plurality of flight types comprising a weight classification, a flight orientation, or any combination thereof.

30. The system of claim 29, further comprising a ground route configuration module configured to generate a ground route configuration for the time period based on the sequence of flights for the time period and gate information for the time period.

31. The system of claim 30, further comprising a gate delay module configured to determine, for each flight, a gate delay time period based on the sequence of flights and the ground route configuration to minimize a weighted taxiway delay.

32. The system of claim 29, further comprising an air route configuration module configured to generate an air route configuration for the time period based on the sequence of flights for the time period and airspace information for the time period.

33. The system of claim 29, further comprising a communication module configured to communicate the runway configuration, the flight-to-runway assignment, the sequence of flights, a ground route configuration, an air route configuration, or any combination thereof, to a plurality of aircraft, a flight management system, or any combination thereof.
